(19) United States
(12) Patent Application Publication
(10) Pub. No.: US 2012/0221225 A1
(43) Pub. Date: Aug. 30, 2012

(54) CONTROLLER FOR INTERNAL COMBUSTION ENGINE

(75) Inventors: Masahiro SHIGENAGA, Okazaki-city (JP); Motomasa Iizuka, Anjo-city (JP); Masatoshi Basaki, Nukata-gun (JP); Makoto Miwa, Kariya-city (JP)

(73) Assignee: DENSO CORPORATION, Kariya-city (JP)

(21) Appl. No.: 13/403,022

(22) Filed: Feb. 23, 2012

(30) Foreign Application Priority Data
Feb. 24, 2011 (JP) 2011-38929

(51) Int. Cl. F02D 28/00

(52) U.S. Cl. 701/102

(57) ABSTRACT

When an engine is driven in a compression self-ignited combustion region, a fuel injector injects a fuel into a cylinder in a negative-valve-overlap period where an exhaust valve and an intake valve are both closed. Then, the fuel is injected into the cylinder in an intake stroke. The injected fuel is compressed in a compression stroke to be self-ignited. When it is determined that a steep combustion occurs and a fuel injection quantity in the negative-valve-overlap period is greater than a lower determination threshold, the fuel injection quantity in the negative-valve-overlap period is reduced. When the fuel injection quantity is not greater than the lower determination threshold, an oxygen quantity in the cylinder is reduced.

### CROSS-REFERENCE TO RELATED APPLICATION

This application is based on Japanese Patent Application No. 2011-38929 filed on Feb. 24, 2011, the disclosure of which is incorporated herein by reference.

### TECHNICAL FIELD

The present disclosure relates to a controller for an internal combustion engine in which a fuel is directly injected into a cylinder during a negative-valve-overlap period and an air-fuel mixture is self-ignited by compressing the air-fuel mixture during a compression stroke. In the negative-valve-overlap period, both an exhaust valve and an exhaust valve are closed.

### BACKGROUND

JP-2005-220839A shows a fuel injection system for improving a fuel economy and reducing emissions, such as nitrogen oxide (NOx). In this fuel injection system, an exhaust valve and an intake valve are both closed during a period from a posterior half of an exhaust stroke to an anterior half of an intake stroke. This period is referred to as a negative-valve-overlap period. In this negative-valve-overlap period, a first fuel injection is conducted. Then, in an intake stroke or a compression stroke, a second fuel injection is conducted. A compressed air-fuel mixture is self-ignited in the compression stroke. The first fuel injection is conducted by a first fuel injector and the second fuel injection is conducted by a second fuel injector. A minimum fuel injection quantity of the first fuel injector is less than that of the second fuel injector.

In the above compression self-ignition combustion control, the fuel is injected into a cylinder in a negative-valve-overlap period to combust a part of fuel so that a temperature in a cylinder is increased, whereby stable compression self-ignition combustion can be realized. However, when the engine is running in a high load, it is likely that the temperature in the cylinder is excessively increased, which may generates a steep combustion causing a knocking and/or combustion noise. In order to restrict such a steep combustion, it is conceivable that the fuel injection quantity in the negative-valve-overlap period should be reduced. However, since the fuel injection quantity which a fuel injector can injects depends on an injection characteristic of the fuel injector, it may be impossible for an ordinary fuel injector to reduce the fuel injection quantity sufficiently in the negative-valve-overlap period.

In the fuel injection system shown in JP-2005-220839A, the minimum fuel injection quantity of the first injector is set less than that of the second fuel injector in order to reduce the fuel injection quantity in the negative-valve-overlap period. In this case, two types of fuel injector are necessary, which increases a manufacturing cost.

### SUMMARY

It is an object of the present disclosure to provide a controller for an internal combustion engine, which is capable of restricting a generation of a steep combustion during a compression self-ignition combustion control and of satisfying a demand for reducing its cost.

According to the present disclosure, a controller for an internal combustion engine includes a combustion control portion which defines a negative-valve-overlap period in which an exhaust valve and an intake valve are both closed at least in a posterior half of an exhaust stroke. The combustion control portion executes a compression self-ignited combustion control in which a fuel is injected into a cylinder in the negative-valve-overlap period and the injected fuel is compressed in a compression stroke to be self-ignited. The controller further includes a combustion determining portion which determines whether a steep combustion exceeding a specified permissible level occurs during the compression self-ignited combustion control. When the combustion determining portion determines that a steep combustion occurs during the compression self-ignited combustion control, the combustion control portion executes a fuel-injection-quantity reducing control in which a fuel injection quantity during the negative-valve-overlap period is reduced in a case that the fuel injection quantity in the negative-valve-overlap period is greater than a lower determination threshold. Further, the combustion control portion executes an oxygen-quantity reducing control in which an oxygen quantity in an exhaust gas remaining in the cylinder during the negative-valve-overlap period is reduced in a case that the fuel injection quantity in the negative-valve-overlap period is not greater than the lower determination threshold.

According to the above configuration, a combustion quantity of the fuel in the negative-valve-overlap period can be reduced and an excessive increase in temperature in a cylinder can be restricted, whereby a steep combustion is restricted.

Meanwhile, when the fuel injection quantity in the negative-valve-overlap period is not greater than the lower threshold, an oxygen-quantity reducing control is executed to reduce an oxygen quantity in combusted gas remaining in the cylinder in the negative-valve-overlap period. By reducing the oxygen quantity, a combustion quantity of the fuel in the negative-valve-overlap period can be reduced and an excessive increase in temperature in a cylinder can be restricted, whereby a steep combustion is restricted.

As above, even in a high load region, a steep combustion is restricted. Thus, a driving range where the compression self-ignited combustion control can be performed can be extended to the high load region. Further, it is unnecessary to provide a fuel injector of which minimum fuel injection quantity is smaller than that of an ordinary fuel injector, which satisfies a low cost demand.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to an embodiment of the present invention;

FIG. 2 is a time chart for explaining a compression self-ignited combustion control;

FIG. 3 is a chart for explaining a fuel-injection reducing control and an oxygen-quantity reducing control;

FIG. 4A is a chart showing a relationship between a fuel injection quantity in a negative-valve-overlap period (NVO-injection quantity), a generated heat quantity in the negative-valve-overlap period (NVO-heat quantity) and a maximum value of the combustion pressure increasing rate (CPIR), in a case that the oxygen-quantity reducing control is not executed;

FIG. 4B is a chart showing a relationship between the NVO-injection quantity, the NVO-heat quantity and the CPIR, in a case that the oxygen-quantity reducing control is executed;

FIG. 5 is a flow chart showing a processing of a combustion control routine;

FIG. 6 is a flow chart showing a processing of a compression self-ignited combustion control routine; and

FIG. 7 is a chart for explaining another embodiment of the present invention.

### DETAILED DESCRIPTION

An embodiment of the present invention will be described hereinafter.

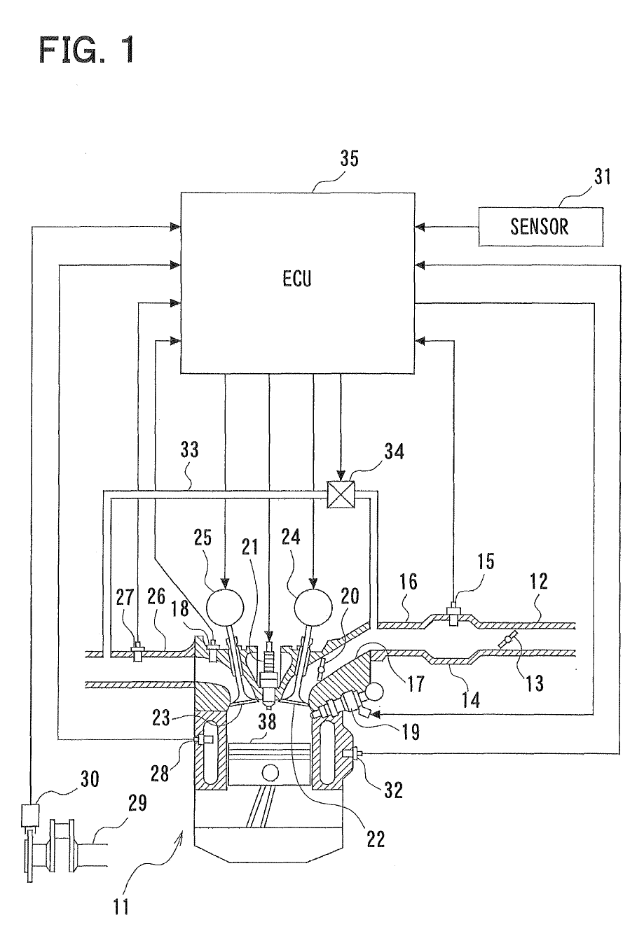

Referring to FIG. 1, an engine control system is explained. An intake pipe (intake passage) 12 of an internal combustion engine 11 is provided with a throttle valve 13 which is driven by a motor (not shown). A surge tank 14 is provided downstream of the throttle valve 13. A pressure sensor 15 detecting an intake pipe pressure is disposed in the surge tank 14. An intake manifold (intake passage) 16 which introduces air into each cylinder of the engine 11 is connected to the surge tank 14.

The internal combustion engine 11 is provided with a fuel injector 19 for each cylinder. The fuel injector 19 injects fuel directly into a combustion chamber. An air flow control valve 20 is disposed at each of the intake ports 17 in order to control air flow intensity (an intensity of swirl flow and an intensity of tumble flow) in each cylinder. A spark plug 21 is disposed for each of the cylinder on a cylinder head of the engine 11.

The engine 11 is provided an intake-side variable valve timing controller 24 which adjusts a valve timing of the intake valve 22, and an exhaust-side variable valve timing controller 25 which adjusts a valve timing of the exhaust valve 23. An exhaust pipe (exhaust passage) 26 of the engine 11 is provided with an exhaust pressure sensor 18 and an exhaust gas sensor (an air-fuel ratio sensor, an oxygen sensor) 27. A catalyst (not shown) such as a three-way catalyst is arranged downstream of the exhaust gas sensor 27.

An EGR pipe 33 connects the exhaust pipe 26 downstream of the exhaust gas sensor 27 and the intake pipe 12 downstream of the throttle valve 16. A part of an exhaust gas is recalculated into the intake pipe 12 through the EGR pipe 33. The EGR pipe 33 is provided with an EGR valve 34 which controls a flow rate of the exhaust gas flowing therethrough.

A coolant temperature sensor 28 detecting a coolant temperature and a knock sensor 32 detecting knocking of the engine are disposed on a cylinder block of the engine 11. A crank angle sensor 30 is disposed at outer circumference of a crank shaft 30 to output a pulse signal every when the crank shaft 29 rotates a specified crank angle. Based on the output signal of the crank angle sensor 30, a crank angle and an engine speed are detected. Further, an accelerator position sensor 31 detects an accelerator operation amount (stepped-amount of an accelerator pedal).

The outputs of the above sensors are transmitted to an electronic control unit (ECU) 35. The ECU 35 includes a microcomputer which executes an engine control program stored in a Read Only Memory (ROM) to control a fuel injection quantity, an ignition timing, a throttle position (intake air flow rate) and the like.

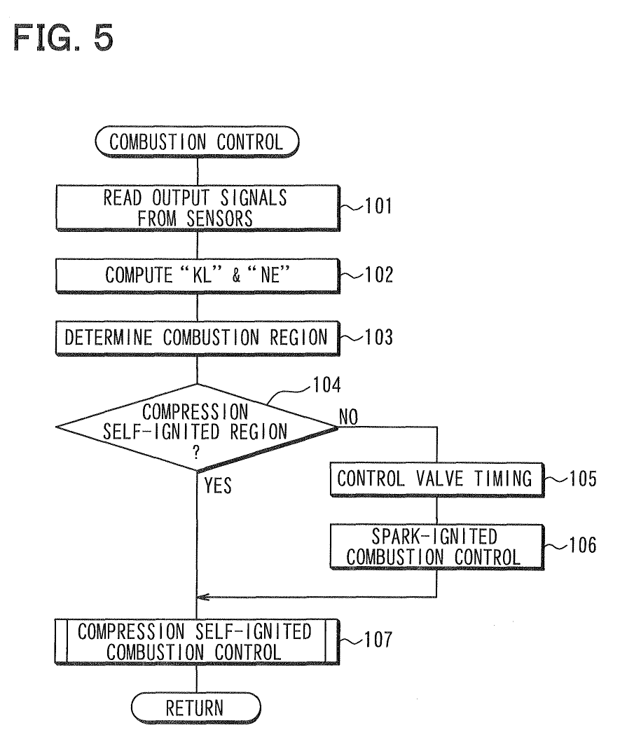

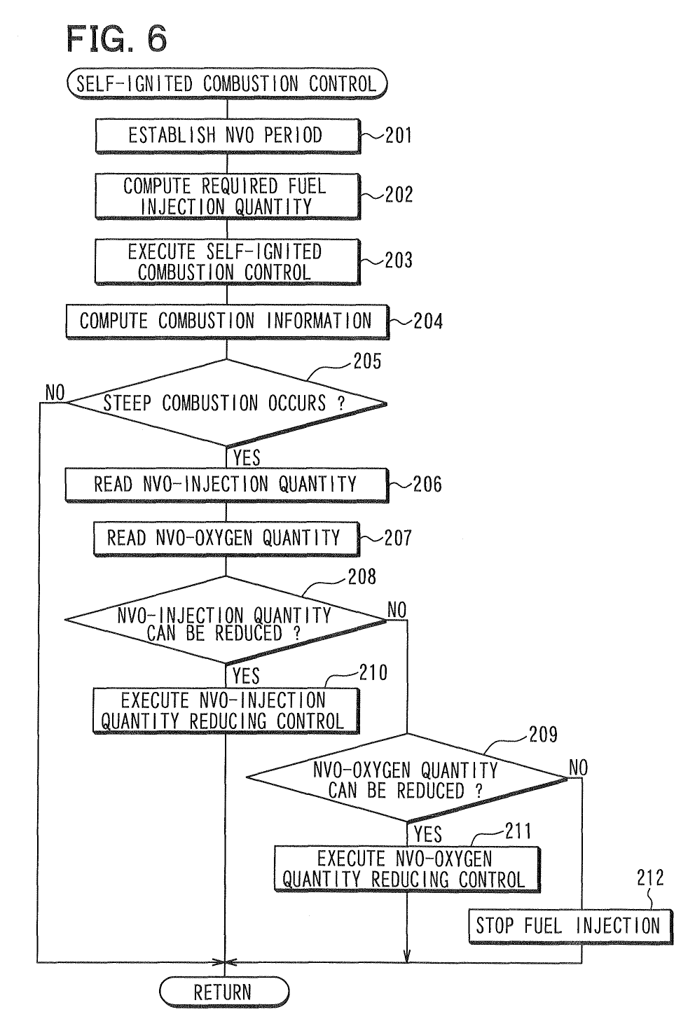

The ECU 35 executes a combustion control routine shown in FIGS. 5 and 6. When the engine driving region is in a specified self-ignited combustion region, a self-ignited combustion control is performed so that the compressed air-fuel is self-ignited and combusted. When the engine driving region is in a spark-ignited combustion region, a spark-ignited combustion control is performed so that the fuel is ignited by the spark discharge of the ignition plug 21 and combusted.

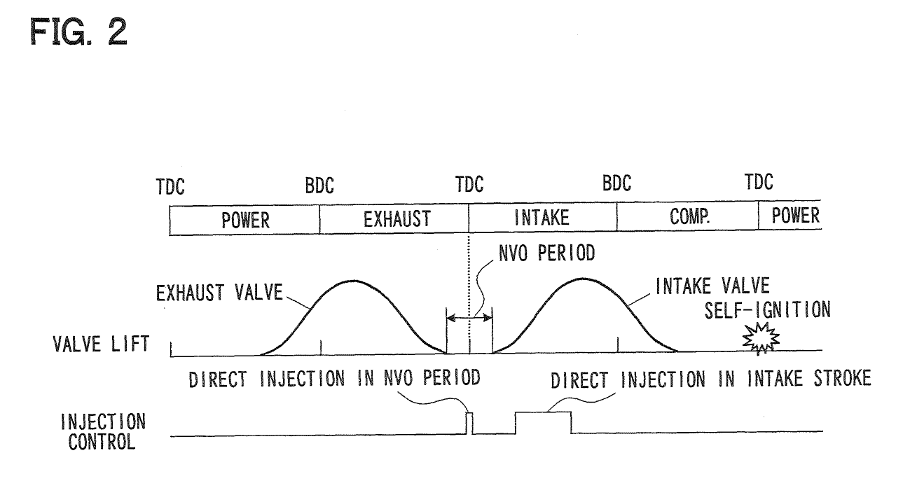

As shown in FIG. 2, in the self-ignited combustion control, the variable valve timing controllers 24, 25 control the valve timing of the intake valve 22 and the exhaust valve 23 to establish a negative-valve-overlap (NVO) period in which both of the exhaust valve 23 and the intake valve 22 is closed at least in a posterior half of the exhaust stroke. For example, the NVO period is established from a posterior half of an exhaust stroke to an anterior half of an intake stroke. The valve timing of the exhaust valve 23 is controlled to advance the closing timing of the exhaust valve 23 relative to a top dead center (TDC), and the valve timing of the intake valve 22 is controlled to retard the opening timing of the intake valve 22 relative to the top dead center. During the NVO period, since a high temperature exhaust gas remaining in the cylinder (internal EGR gas) is compressed by a piston 38 in the posterior half of the exhaust stroke, the temperature and pressure in the cylinder are increased.

The fuel injector 19 injects the fuel into the combustion chamber in the NVO period. This injected fuel is exposed to high temperature and high pressure in the combustion chamber. Thus, a preliminary reaction of the combustion is started and a part of the fuel starts to be combusted, whereby the temperature in the cylinder is further increased.

Then, the fuel injector 19 injects the fuel in the intake stroke (or in the compression stroke). The fuel injected in the intake stroke (or the compression stroke) and the fuel injected in the NVO period is mixed so that an air-fuel mixture is generated in the cylinder. Then, when the temperature in the cylinder more increased in the compression stroke, the fuel is self-ignited to combust the air-fuel mixture. That is, the compression self-ignited combustion of the air-fuel mixture is performed.

It should be noted that the second fuel injection is not always necessary to perform the compression self-ignited combustion.

As described above, in the compression self-ignition combustion control, the fuel is injected into a cylinder in the NVO period to combust a part of fuel so that a temperature in a cylinder is increased, whereby a stable compression self-ignition combustion can be realized. However, when the engine is running in a high load, it is likely that the temperature in the cylinder is excessively increased, which may generates a steep combustion causing a knocking and/or combustion noise. In order to restrict such a steep combustion, it is conceivable that the fuel injection quantity in the NVO period is reduced. However, since the fuel injection quantity which a fuel injector 19 can injects depends on an injection characteristic of the fuel injector 19, it may be impossible for an ordinary fuel injector 19 to reduce the fuel injection quantity sufficiently in the NVO period.

According to the present embodiment, the ECU 35 determines whether a steep combustion occurs during a compression self-ignited combustion control, which exceeds a specific permissible level. The steep combustion exceeding the specified level corresponds to a combustion in which a combustion pressure increasing rate is increased to generate a knocking and a combustion noise. Alternatively, the steep combustion exceeding the specified level corresponds to a combustion in which a combustion timing (an ignition timing, a combustion center, etc.) is advanced relative to a most optimum combustion timing at which the efficiency of the engine is highest. When the computer determines that a steep combustion occurs in the compression self-ignition combustion control, it is determined whether the fuel injection quantity in the NVO period can be reduced based on whether the fuel injection quantity in the NVO period is greater than a lower threshold. The lower threshold, for example, is a minimum fuel injection quantity which the fuel injector 19 can inject.

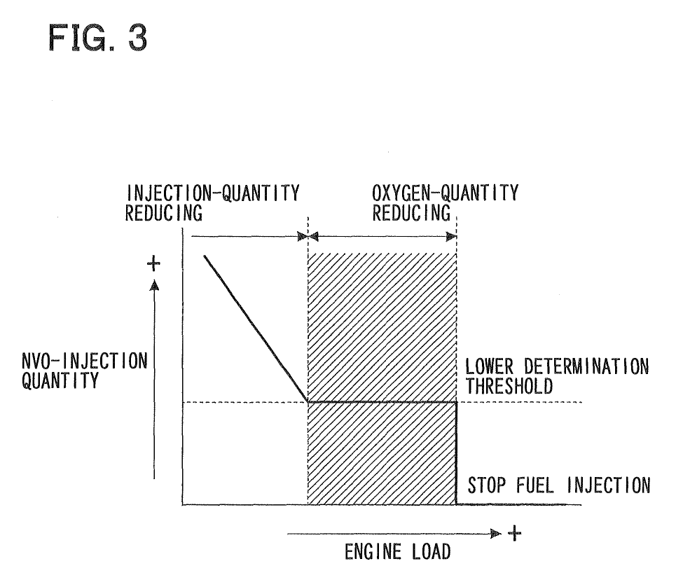

As shown in FIG. 3, in a region where the fuel injection quantity in the NVO period is greater than the lower threshold, an NVO-injection-quantity reducing control is executed to reduce the fuel injection quantity in the NVO period. Thereby, a combustion quantity of the fuel in the NVO period can be reduced and an excessive increase in temperature in a cylinder can be restricted, whereby a steep combustion is restricted.

Meanwhile, in a region where the fuel injection quantity in the NVO period is not greater than the lower threshold, an NVO-oxygen-quantity reducing control is executed to reduce an oxygen quantity in combusted gas remaining in the cylinder in the NVO period. This oxygen quantity is referred to as an NVO-oxygen-quantity. By reducing the NVO-oxygen-quantity, a combustion quantity of the fuel in the NVO period can be reduced and an excessive increase in temperature in a cylinder can be restricted, whereby a steep combustion is restricted.

Moreover, in a region where the NVO-oxygen quantity can not be reduced or in a region where a compression self-ignited combustion can be performed without injecting the fuel during the NVO period, the fuel injector 10 injects no fuel in the NVO period. Thus, the combustion of the fuel is stopped in the NVO period and an excessive increase in temperature in a cylinder can be restricted, whereby a steep combustion is restricted.

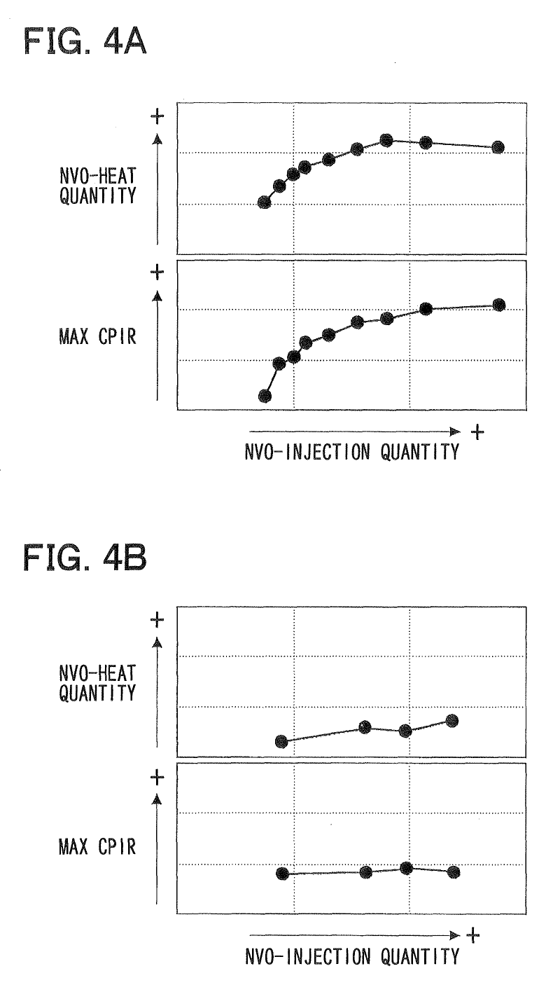

FIG. 4A is a chart showing a relationship between the fuel injection quantity in the NVO period (NVO-injection quantity), a generated heat quantity in the NVO period (NVO-heat quantity) and a maximum value of the combustion pressure increasing rate (CPIR), in a case that the NVO-oxygen-quantity reducing control is not executed. As shown in FIG. 4A, when the NVO-injection quantity is increased, the NVO-heat quantity is increased and the maximum value of the CPIR is also increased, whereby the fuel combustion becomes steeper.

FIG. 4B is a chart showing a relationship between the fuel injection quantity in the NVO period (NVO-injection quantity), a generated heat quantity in the NVO period (NVO-heat quantity) and a maximum value of the combustion pressure increasing rate (CPIR), in a case that the NVO-oxygen-quantity reducing control is executed. As shown in FIG. 4B, even when the NVO-injection quantity is increased, the NVO-heat quantity is slightly increased and the maximum value of the CPIR is almost constant.

As described above, in a case where the NVO-injection quantity can be reduced, the NVO-injection quantity reducing control is executed to reduce the NVO-injection quantity, whereby the CPIR is decreased and a steep fuel combustion can be restricted. Meanwhile, in a case where the NVO-injection quantity can not be reduced, the NVO-oxygen quantity reducing control is executed to reduce the NVO-oxygen quantity, whereby the CPIR is decreased and a steep fuel combustion can be restricted.

Referring to FIGS. 5 and 6, the processes of each routine for a combustion control will be described hereinafter.

### [Combustion Control Routine]

A combustion control routine shown in FIG. 5 is executed at a specified cycle while the ECU 35 is ON. This combustion control routine corresponds to a combustion control portion. In step 101, the output signals from the accelerator position sensor 31, the crank angle sensor 30 and the like are read. In step 102, an accelerator position is computed based on the output signals from the accelerator position sensor 31. The accelerator position is used as an engine load KL, and an engine speed NE is computed based on the output signals from the crank angle sensor 30. Besides, an intake air quantity and an intake air pressure can be used as the engine load KL.

Then, the procedure proceeds to step 103 in which the ECU 35 determines whether a present engine driving region (engine load KL and engine speed NE) is in a compression self-ignited combustion region or a spark-ignited combustion region in view of a combustion region determining map (not shown). The combustion region determining map is previously formed based on a design data, an examination data, a simulation data and the like. This map is stored in the ROM of the ECU 35. In the combustion region determining map, for example, a region where the engine speed and the engine load are low is defined as a compression self-ignited combustion region, and the other region is defined as the spark-ignited combustion region.

Then, the procedure proceeds to step 104 in which the ECU 35 determines whether the present driving region is the compression self-ignited combustion region based on a determination result in step 103. When the answer is NO in step 104, the procedure proceeds to step 105 in which a valve timing control for the spark-ignited combustion is performed. In the valve timing control for the spark-ignited combustion, the variable valve timing controllers 24, 25 control the valve timings of the intake valve 22 and the exhaust valve 23 according to the present engine driving condition (engine load KL, engine speed Ne, etc.).

Then, the procedure proceeds to step 106 in which fuel injection quantity of the fuel injector 19 is controlled according to the present engine driving condition, and the spark-ignited combustion control is performed by controlling the ignition timing of the spark plug 21 according to the present engine driving condition.

When the answer is YES in step 104, the procedure proceeds to step 107 in which a compression self-ignited combustion control, which is shown in FIG. 6, is executed.

### [Compression Self-Ignited Combustion Control Routine]

A compression self-ignited combustion control routine shown in FIG. 6 is a subroutine executed in step 107. In step 201, the variable valve timing controllers 24, 25 controls valve timings of the intake valve and the exhaust valve so that the NVO-period is established.

Then, the procedure proceeds to step 202 in which a required fuel injection quantity in the NVO-period and a required fuel injection quantity in the intake stroke (or the compression stroke) are computed according to the present engine driving condition by use of maps or formulas. These maps or formulas are previously obtained based on a design data, an experiment data and a simulation data, and are stored in the ROM of the ECU 35.

Then, the procedure proceeds to step 203 in which the compression self-ignited combustion control is executed. That is, the fuel injector 19 injects the fuel into the cylinder in the NVO-period and the intake stroke (or compression stroke) to self-ignite the air-fuel mixture compressed in the compression stroke.

Then, the procedure proceeds to step 204 in which a combustion-condition information is computed for determining a combustion condition of during the compression self-ignited combustion control. Specifically, based on detection signals of the knock sensor 32, a knock vibration index (for example, a peak value or an integrated value of a vibration waveform in a specified frequency band) is computed. This knock vibration index is used as the combustion-condition information.

Then, the procedure proceeds to step 205 in which it is determined whether a steep combustion exceeding the specified level occurs based on whether the combustion-condition information exceeds a specified determination value.

When it is determined in step 205 that a steep combustion occurs, the procedure proceeds to step 206 in which a current NVO-injection quantity is read. The required fuel injection quantity in the NVO period may be defined as the NVO-injection quantity. Alternatively, the NVO-injection quantity may be computed (estimated) based on an injection pressure and an injection interval of the fuel injector 19.

Then, the procedure proceeds to step 207 in which the current NVO-oxygen quantity is read. It can be assumed that an oxygen concentration in a cylinder during the NVO period is almost equal to an oxygen concentration of the exhaust gas. The oxygen concentration in a cylinder during the NVO period is detected based on the detection signal of the exhaust gas sensor 27. The ECU 35 computes an exhaust gas quantity in a cylinder of a time when the exhaust valve 23 is closed based on an exhaust pipe temperature, an exhaust pressure and a volume of a cylinder. Then, the NVO-oxygen quantity is computed (estimated) based on the exhaust gas quantity and the oxygen concentration.

Then, the procedure proceeds to step 208 in which the ECU 35 determines whether the NVO-injection quantity can be reduced based on whether the current NVO-injection quantity is greater than a specified lower determination threshold. A minimum fuel injection quantity which the fuel injector 19 can inject is defined as the lower determination threshold.

When the answer is YES in step 208, the procedure proceeds to step 210 in which the NVO-injection-quantity reducing control is executed. In the NVO-injection-quantity reducing control, the required fuel injection quantity of during the NVO period is corrected to be decreased, whereby the NVO-injection quantity is decreased. In this case, the correction quantity may be a predetermined fixed value. Alternatively, the correction quantity may be established according to the current NVO-injection quantity and the engine driving condition. Further, the required fuel injection quantity of during the NVO period is guarded by the lower determination threshold so that the corrected required fuel injection quantity does not fall below the lower determination threshold.

Meanwhile, when the answer is NO in step 208, the procedure proceeds to step 209 in which the ECU 35 determines whether the NVO-oxygen quantity can be reduced based on the current NVO-oxygen quantity and the engine driving condition.

When the answer is YES in step 209, the procedure proceeds to step 211 in which the NVO-oxygen-quantity reducing control is executed. In the NVO-oxygen-quantity reducing control, the ECU 35 executes at least one of an external-EGR-increasing control and a throttle-position control. In the external-EGR-increasing control, an exhaust gas quantity reticulating from the exhaust pipe 26 to the intake pipe 12 is increased. In the throttle-position control, an opening degree of the throttle valve 13 is decreased. By executing the external-EGR-increasing control or the throttle-position control, the air quantity introduced into the cylinder can be reduced and the oxygen quantity remaining in the cylinder after a combustion can be reduced. Thus, the NVO-oxygen quantity can be reduced. In this case, the increasing quantity of the external EGR and the decreasing quantity of the throttle opening may be predetermined fixed values. Alternatively, these quantities may be established according to the current NVO-oxygen quantity and the engine driving condition.

Meanwhile, when the answer is NO in step 209, the procedure proceeds to step 212 in which the fuel injection in the NVO period is stopped. Besides, when the ECU 35 determines that the compression self-ignited combustion can be performed without injecting fuel in the NVO period, the procedure proceeds to step 212 in which the fuel injection in the NVO period is stopped.

If a variation in the combustion condition is small after executing the NVO-injection-quantity reducing control, the NVO-oxygen-quantity reducing control may be executed even though the ECU 35 determines that the NVO-injection quantity can be reduced.

According to the present embodiment, when the ECU 35 determines that a steep combustion occurs during a compression self-ignited combustion control and the NVO-injection quantity is greater than the lower determination threshold, the NVO-injection-quantity reducing control is executed, whereby a combustion quantity of the fuel in the NVO period can be reduced and an excessive increase in temperature in a cylinder can be restricted. Thus, a steep combustion is restricted. Meanwhile, when the NVO-injection quantity is not greater than the lower determination threshold, the NVO-oxygen-quantity reducing control is executed. The combustion quantity of the fuel in the NVO period can be reduced and an excessive increase in temperature in a cylinder can be restricted, whereby a steep combustion is restricted. Even in a high load region, a steep combustion is restricted. Thus, a driving range where the compression self-ignited combustion control can be performed can be extended to the high load region. Further, it is unnecessary to provide a fuel injector of which minimum fuel injection quantity is smaller than that of an ordinary fuel injector, which satisfies a low cost demand.

In the above embodiment, the minimum fuel injection quantity which the fuel injector 19 can injects is defined as the lower determination threshold. However, a fuel injection quantity which is slightly larger than the minimum fuel injection quantity may be defined as the lower determination threshold.

In the above embodiment, the external-EGR-increasing control and/or the throttle-position control is executed as the NVO-oxygen-quantity reducing control. If these controls can not be executed, a gas-injection control may be executed. In the gas-injection control, gas including carbon dioxide (CO₂) and/or nitrogen (N₂) is injected into a cylinder during the NVO period. The oxygen concentration in the cylinder can be reduced. The gas-injection control is executed in view of the NVO-oxygen quantity. The gas is injected through an injector which has the same configuration as the fuel injector 19.

Alternatively, as the NVO-oxygen-quantity reducing control, a valve close timing of the exhaust valve 23 may be retarded when the NVO-oxygen concentration is higher than a reference value. In this case, since an internal EGR quantity (exhaust gas remaining in a cylinder) may be reduced and the intake air flow rate may be increased, an external EGR increasing control, the throttle control and the gas-injection control may be combined.

When the NVO-injection-quantity reducing control is executed, an injection pressure of the fuel injector 19 is not usually changed. If it is necessary to further decrease the NVO-injection quantity, the injection pressure of the fuel injector 19 may be decreased than usual.

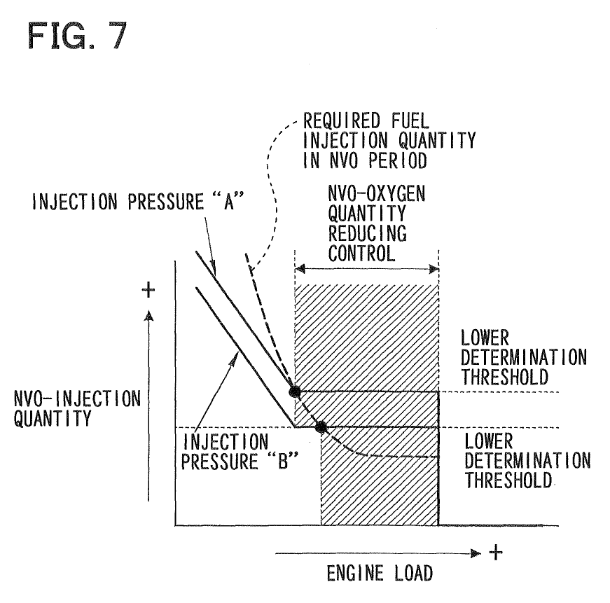

As shown in FIG. 7, when the injection pressure of the fuel injector 19 is varied, the injection characteristic of the fuel injector 19 is varied and the minimum fuel injection quantity is also varied. Further, the lower determination threshold is varied and a start timing of the NVO-oxygen-quantity reducing control is varied.

In view of the above, when the fuel injector 19 injects the fuel, a required fuel injection quantity in the NVO period is stored in a nonvolatile memory of the ECU 35 as a switching determination value. The switching determination value is learned every when the fuel injector 19 injects the fuel. During the compression self-ignited combustion control, based on the injection pressure of the fuel injector 19 and the learning value of the switching determination value, a proper start timing of the NVO-oxygen-quantity reducing control is estimated. Also, based on a deviation in learning values of the switching determination value, a deviation in fuel injection quantity due to adhering deposit on the fuel injector 19 and a variation in cylinder interior environment can be determined.

When the NVO-injection-quantity reducing control and/or the NVO-oxygen-quantity reducing control is performed, the NVO-injection quantity and/or the NVO-oxygen quantity may be adjusted based on the detection signal of the combustion temperature sensor.

Based on detection signals of a noise sensor detecting an engine noise or a combustion pressure sensor detecting a combustion pressure, it can be determined whether a steep combustion occurs. Alternatively, based on an ion current detected through electrodes of the spark plug 21, it can be determined whether a steep combustion occurs.

Specifically, it can be determined whether a steep combustion occurs based on whether a peak time point of a differentiation value of the ion current is advanced relative to a proper time point.

In the above embodiment, the fuel injector 19 injects the fuel in the NVO period and the intake stroke (or compression stroke). However, a fuel injector for direct injection and a fuel injector for port injection may be provided. The fuel injector for direct injection injects the fuel in the NVO period and the fuel injector for port injection injects the fuel in the intake stroke. Alternatively, some of the fuel injectors for direct injection may inject the fuel in the NVO period, and the other fuel injectors for direct injection may inject the fuel in the intake stroke.

What is claimed is:

1. A controller for an internal combustion engine, comprising:
a combustion control portion which defines a negative-valve-overlap period in which an exhaust valve and an intake valve are both closed at least in a posterior half of an exhaust stroke, and which executes a compression self-ignited combustion control in which a fuel is injected into a cylinder in the negative-valve-overlap period and the injected fuel is compressed in a compression stroke to be self-ignited; and
a combustion determining portion which determines whether a steep combustion exceeding a specified permissible level occurs during the compression self-ignited combustion control, wherein
when the combustion determining portion determines that a steep combustion occurs during the compression self-ignited combustion control,
(i) the combustion control portion executes a fuel-injection-quantity reducing control in which a fuel injection quantity during the negative-valve-overlap period is reduced in a case that the fuel injection quantity in the negative-valve-overlap period is greater than a lower determination threshold, and
(ii) the combustion control portion executes an oxygen-quantity reducing control in which an oxygen quantity in an exhaust gas remaining in the cylinder during the negative-valve-overlap period is reduced in a case that the fuel injection quantity in the negative-valve-overlap period is not greater than the lower determination threshold.

2. A controller for an internal combustion engine according to claim 1, wherein
the lower determination threshold is defined to a minimum fuel injection quantity which the fuel injector can inject into the cylinder in the negative-valve-overlap period.

3. A controller for an internal combustion engine according to claim 1, wherein
as the oxygen-quantity reducing control, the combustion control portion executes at least one of an EGR control and a throttle valve control,
an exhaust gas quantity recalculating from an exhaust passage to an intake passage is increased in the EGR control, and
an opening degree of a throttle valve is decreased in the throttle valve control.

4. A controller for an internal combustion engine according to claim 1, wherein
as the oxygen-quantity reducing control, the combustion control portion executes a gas-injection control in which a gas including at least one of carbon dioxide and nitrogen is injected into the cylinder in the negative-valve-overlap period.

5. A controller for an internal combustion engine according to claim 1, wherein
a combustion determining portion determines whether the steep combustion occurs during the compression self-ignited combustion control, based on at least one of a combustion pressure, a knock vibration index and an ion current.
